(19) United States
(12) Patent Application Publication
(10) Pub. No.: US 2025/0236053 A1
(43) Pub. Date: Jul. 24, 2025

(54) METHOD FOR MOLDING ELASTIC BODY AND ELASTIC BODY MOLDING DEVICE

(71) Applicant: MITSUBISHI CABLE INDUSTRIES, LTD., Tokyo (JP)

(72) Inventors: Kenji KAWAMURA, Amagasaki-shi (JP); Ryohei TAKEDA, Amagasaki-shi (JP); Hironori OIDA, Amagasaki-shi (JP); Tetsuya YAMAMOTO, Arida-shi (JP)

(73) Assignee: MITSUBISHI CABLE INDUSTRIES, LTD., Tokyo (JP)

(21) Appl. No.: 19/173,456

(22) Filed: Apr. 8, 2025

Related U.S. Application Data
(63) Continuation of application No. PCT/JP2023/034103, filed on Sep. 20, 2023.

(30) Foreign Application Priority Data
Nov. 8, 2022 (JP) 2022-178621

(51) Int. Cl. B29C 43/34; B29C 43/00; B29C 43/52; B29K 83/00

(52) U.S. Cl. CPC B29C 43/34; B29C 43/003; B29C 43/52; B29C 2043/3433; B29K 2083/005

(57) ABSTRACT

A method for molding an elastic body includes supplying a molding material having flowability to an upper surface of a mold attached to a press machine from a movable supply nozzle provided at a tip end of a molding material supply device such that the molding material is raised, moving the supply nozzle to cause the supply nozzle to avoid the mold, and molding a molded product by performing clamping of the press machine and pressuring and heating the molding material while filling the molding material into a cavity of the mold.

### CROSS-REFERENCE TO RELATED APPLICATIONS

This is a continuation of International Application No. PCT/JP2023/034103 filed on Sep. 20, 2023, which claims priority to Japanese Patent Application No. 2022-178621 filed on Nov. 8, 2022. The entire disclosures of these applications are incorporated by reference herein.

### BACKGROUND

### 1. Field of the Invention

The present disclosure relates to a method for molding an elastic body, such as silicone rubber or the like, and an elastic body molding device.

### 2. Description of the Related Art

Conventionally, a method for molding an elastic body in which an elastic body is formed of silicone rubber using compression molding has been known.

Compression molding has the following problems.
Preparatory molding is required and a preparatory molding step cannot be omitted, and therefore, a lead time is long and a large number of steps have to be performed.
A material that is used requires preparatory molding and thus has high viscosity and poor flowability, as compared to a material used for injection molding. Therefore, it is difficult to evenly fill the material into a mold up to all edges of the mold.
Quality of a molded product is dependent on thickness precision and a set position into a mold in preparatory molding.

In contrast, for example, as described in Japanese Unexamined Patent Publication No. 2019-198999, known is a method for manufacturing a liquid jetting device provided with a valve mechanism including a valve seat in which a flow path is formed and an elastic body that opens and closes the flow path by contacting the valve seat and separating from the valve seat, in which the elastic body is formed by injection molding.

### SUMMARY

However, the injection molding described above has the following problems.
It is difficult to inject a large amount of a material into a mold in a short time (several seconds).
It is necessary to provide multiple (many) gates used for injecting the material and gate designing (number and position) is difficult.
As compared to compression molding, a high injection pressure is needed and installation cost is high.
In general, a structure of an injection molding mold is more complicated than that of a compression molding mold, and cost for manufacturing a mold is high.

In view of the foregoing, the present disclosure has been devised, and it is therefore an object of the present disclosure to enable molding of a molded product with high quality in a simple manner without requiring preparatory molding.

In order to achieve the object described above, according to a technology described in the present disclosure, a molding material having flowability is supplied to an upper surface of a mold attached to a press machine without performing preparatory molding.

Specifically, a method for molding an elastic body according to a first aspect of the present disclosure includes supplying a molding material having flowability to an upper surface of a mold attached to a press machine from a movable supply nozzle provided at a tip end of a molding material supply device such that the molding material is raised, moving the supply nozzle to cause the supply nozzle to avoid the mold, and molding a molded product by performing clamping of the press machine and pressuring and heating the molding material while filling the molding material into a cavity of the mold.

According to the above-described configuration, the molding material having flowability is supplied to the upper surface of the mold attached to the press machine, and therefore, preparatory molding can be omitted and a compression mold having a simple structure without an injection gate can be used, so that manufacturing cost can be reduced. Moreover, a molded product can be molded at a lower temperature, as compared to normal compression molding, and a shrinkage rate is small, so that the highly precise molded product can be obtained.

In a second aspect of the present disclosure, in the method for molding an elastic body according to the first aspect, the mold includes an upper mold, a lower mold, and a core that is interposed between the upper mold and the lower mold to form the cavity and the molding material having flowability to an upper surface of the core such that the molding material is raised.

According to the above-described configuration, the core is used, so that a molded product having a complicated shape including an under shape can be easily molded.

In a third aspect of the present disclosure, the method for molding an elastic body according to the first or second aspect further includes rotating the supply nozzle to cause the supply nozzle to avoid the mold.

According to the above-described configuration, the supply nozzle can be caused to avoid the mold to perform clamping of the mold by a simple configuration, and therefore, molding is easy.

In a fourth aspect of the present disclosure, in the method for molding an elastic body according to any one of the first to third aspects, the molding material is liquid silicone rubber and is pressurized and heated by the press machine to be heat cured.

Conventionally, liquid silicone rubber (LSR) is molded by injection molding. However, according to the above-described configuration, molding can be performed at a low temperature, as compared to injection molding, so that variations in outer shape dimensions can be suppressed and a highly precise silicone rubber molded body can be obtained.

In a fifth aspect of the present disclosure, in the method for molding an elastic body according to the fourth aspect, the molding material is a mixture of two or more liquid silicone rubbers and is pressurized and heated by the press machine to be heat cured.

In a sixth aspect of the present disclosure, in the method for molding an elastic body according to the any one of the first to fifth aspects, when the molding material is supplied from the supply nozzle, the supply nozzle is lifted as the molding material is raised.

According to the above-described configuration, even when a large amount of the molding material is supplied at a high speed, the supply nozzle is not buried in the raised molding material and entrapping of air is also prevented.

In a seventh aspect of the present disclosure, the method for molding an elastic body according to the any one of the first to sixth aspects further includes cutting, after supply of the molding material from the supply nozzle ends, a connection portion of the supply nozzle and the molding material.

According to the above-described configuration, surroundings can be kept from soiling by reliably preventing dripping of the molding material from the supply nozzle.

An elastic body molding device according to an eighth aspect of the present disclosure includes a molding material supply device that mixes two or more liquid silicone rubbers to supply a liquid molding material, a supply nozzle that can move to change a supply position in which the molding material that is supplied from the molding material supply device is suppled, and a press machine that molds a molded product by receiving the supply nozzle between parts of a mold attached to the press machine, supplying the molding material with flowability that is supplied from the supply nozzle to an upper surface of the mold such that the molding material is raised, and performing clamping in a state where the supply nozzle is moved to avoid the mold and pressurizing and heating the molding material while filling the molding material into a cavity of the mold.

According to the above-described configuration, the molding material having flowability is supplied to an upper surface of a lower mold of the press machine, so that preparatory molding can be omitted and a compression mold having a simple structure without an injection gate can be used. Therefore, cost for them old can be suppressed and maintenance and management of the mold is easy and thus maintenance cost can be suppressed. Moreover, a molded product can be molded at a lower temperature, as compared to normal compression molding, and a shrinkage rate is small, so that the highly precise molded product can be obtained. Furthermore, the press machine having a relatively simple structure can be employed without using an injection molding machine that requires a large-scale facility.

Conventionally, liquid silicone rubber is molded by injection molding but, according to the above-described configuration, molding can be performed at a low temperature, as compared to injection molding, so that variations in outer shape dimensions can be suppressed and a highly precise silicone rubber molded body can be obtained.

As has been described above, according to the present disclosure, respective problems of injection molding and compression molding are solved, and inexpensive and highly precise molding of an elastic body can be performed.

### BRIEF DESCRIPTION OF THE DRAWINGS

FIG. 1 is a plan view illustrating an outline of a stand-by attitude of an elastic body molding device according to an embodiment.

FIG. 2 is a plan view illustrating an outline of a supply attitude of the elastic body molding device according to the embodiment.

FIG. 3A is an enlarged side view illustrating a supply nozzle and surroundings of the supply nozzle in a supply attitude.

FIG. 3B is an enlarged side view illustrating the supply nozzle and surroundings of the supply nozzle in a state after supplying a molding material.

FIG. 3C is an enlarged side view illustrating the supply nozzle and surroundings of the supply nozzle during shifting from a retreat attitude to mold clamping.

FIG. 4A is a side view corresponding to FIG. 3A in a modified example.

FIG. 4B is a side view corresponding to FIG. 3B in a modified example.

FIG. 4C is a side view corresponding to FIG. 3C in a modified example.

FIG. 5A is a front view illustrating an outline of an outer shape of a silicone rubber molded body.

FIG. 5B is a cross-sectional view illustrating the silicone rubber molded body.

FIG. 6 is a flowchart illustrating a method for molding a silicone rubber molded body according to the embodiment.

### DETAILED DESCRIPTION

Embodiments of the present disclosure will be described below with reference to the accompanying drawings.

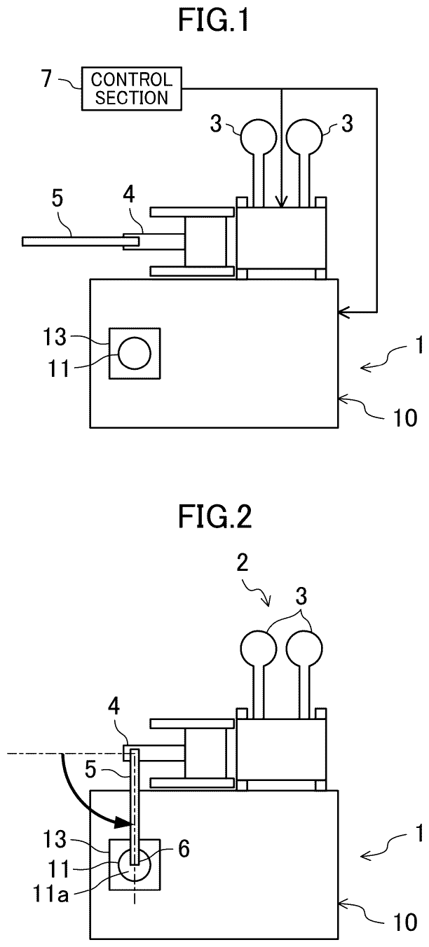

FIG. 1 and FIG. 2 illustrates an outline of a silicone rubber molded body manufacturing device 1 according to an embodiment of the present disclosure. The silicone rubber molded body manufacturing device 1 includes an LSR supply device 2 as a molding material supply device that mixes two liquid silicone rubbers (liquid A and Liquid B) to supply liquid silicone rubber (LSR) as a liquid molding material. Although the LSR supply device 2 is a known device and detailed description thereof will be omitted, the LSR supply device 2 includes a pail pump 3 that sucks up a liquid material. The LSR supply device 2 includes a pump syringe that sends two liquid materials that have been sucked up at a proper ratio and a static mixer 4 that mixes the two liquids, and a nozzle rotation mechanism 5 is provided at a tip end side of the static mixer 4. Viscosity of each of the two liquid silicone rubber materials is about 500 to 1000 pas. For example, each of the liquid A and the liquid B is a silicone-based liquid and a crosslinking agent and a platinum catalyst are added to the liquid A and the liquid B such that one of the crosslinking agent and the platinum catalyst is added to one of the liquid A and the liquid B and the other one of the crosslinking agent and the platinum catalyst is added to the other one of the liquid A and the liquid B. For example, specifically, the liquid A includes a vinyl group-containing silicone polymer, a platinum catalyst, a filler, and a hardening inhibitor, and the liquid B includes a vinyl group-containing silicone polymer, a Si—H group-containing silicone polymer (crosslinking agent), a filler, and a hardening inhibitor.

In the drawings, a control section (controller) 7 formed of a microcomputer or the like is configured to control the entire silicone rubber molded body manufacturing device 1, but the LSR supply device 2 and a press machine 10 may be controlled by different control sections.

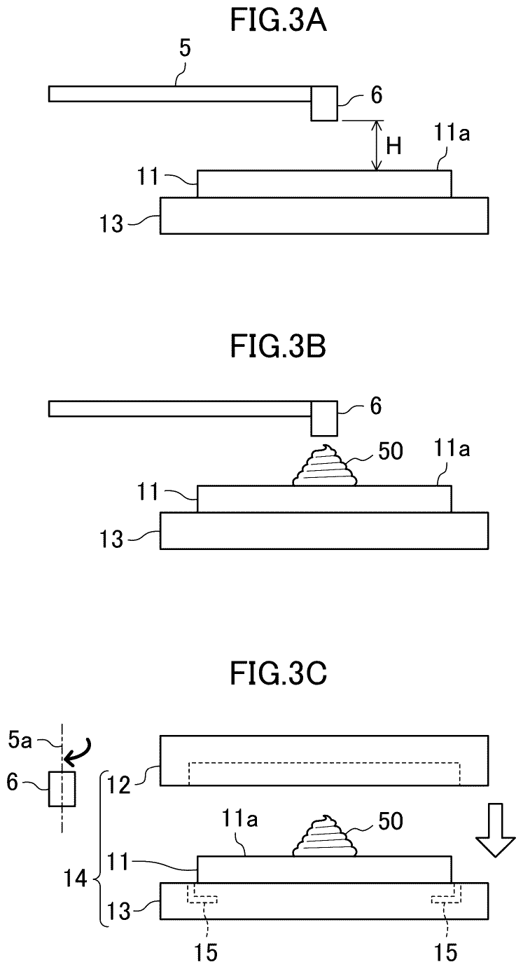

As illustrated in FIG. 2 and FIG. 3C, the nozzle rotation mechanism 5 is configured such that a base end side thereof is rotatable around a rotating shaft 5a by an electric motor, a manual operation, or the like, and can discharge liquid silicone rubber that has been supplied from the static mixer 4 by a supply nozzle 6 provided at a tip end side. The nozzle rotation mechanism 5 is configured, for example, to be rotatable by about 90 degrees between a retreat position (illustrated in FIG. 1) distant from the press machine 10 and a supply position (illustrated in FIG. 2) substantially immediately over a core 11 of the press machine 10 that will be described later. A bore of the supply nozzle 6 has, for example, a diameter of 10 mm to 15 mm and a flow rate is about 60 g/sec (53 cc/sec). Note that the supply nozzle 6 may be caused to slide and move to the retreat position by horizontal movement, not rotated.

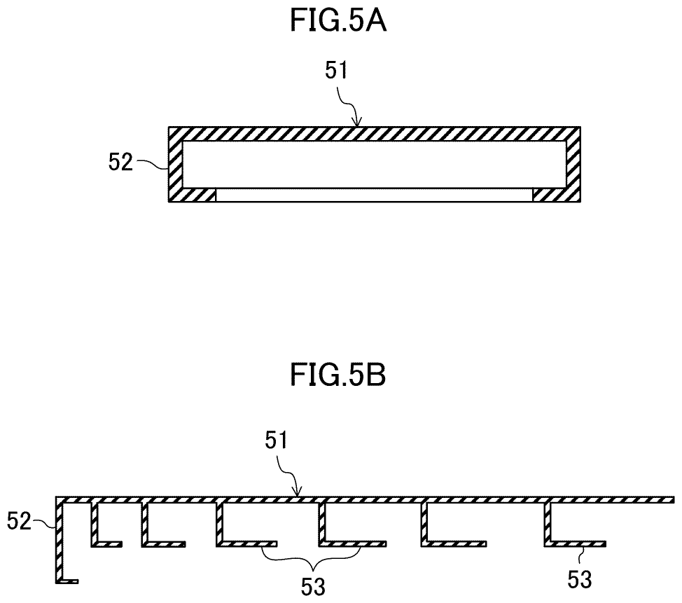

As also illustrated in FIG. 3A to FIG. 3C, the press machine 10 includes a lower mold 13 and an upper mold 12 (omitted in FIG. 3A and FIG. 3B) that form a mold 1 that can be opened and closed. Although details are not illustrated, the core 11 formed of multiple components is provided between the lower mold 13 and the upper mold 12, so that a cavity 15 used for molding a silicone rubber molded body 51 is formed. The supply nozzle 6 can be received between the upper mold 12 and the lower mold 13 and the core 11 in a mold open state. In this embodiment, for example, the silicone rubber molded body 51 that is a membrane that covers a wafer suction section of a semiconductor fabrication device and serves as an elastic body is an object to be molded. The silicone rubber molded body 51 has a thin disk-like shape including a side wall 52 an outer shape of which is illustrated in FIG. 5A and, in an actual situation, may have a complicated shape including many ribs 53 at a back side, as illustrated in FIG. 5B. Each of the lower mold 13, the core 11, and the upper mold 12 is set, for example, at a vulcanizing temperature of about 110° C. to 130° C.

The liquid silicone rubber with flowability that has been supplied from the supply nozzle 6 is supplied to an upper surface 11a of the core 11 so as to be raised therefrom, as illustrated in FIG. 3B. Then, the press machine 10 is configured, as illustrated in FIG. 3C, to mold a molded product by performing clamping of the mold in a state where the supply nozzle 6 is rotated to avoid the mold and pressurizing and heating the liquid silicone rubber while filling the liquid silicone rubber into the cavity 15 (details are not illustrated) of the lower mold 13 and the upper mold 12.

### —Method for Molding Silicone Rubber Molded Body—

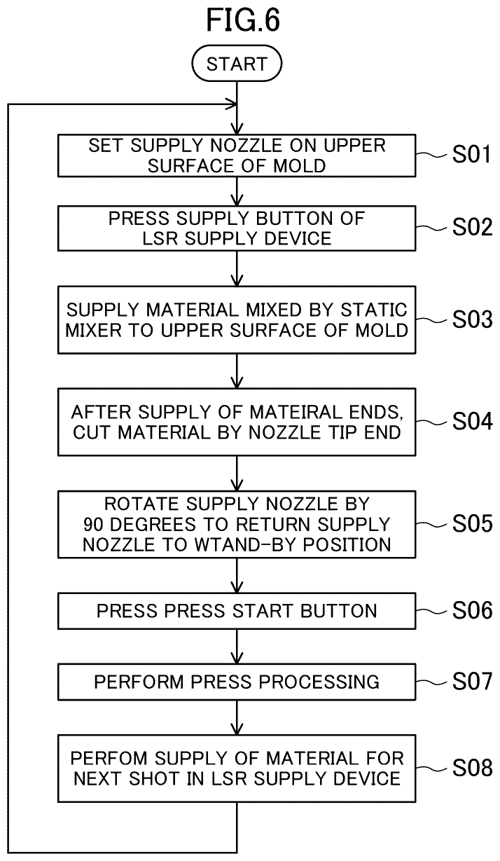

Next, a method for molding the silicone rubber molded body 51 according to this embodiment will be described with reference to FIG. 6.

First, in the silicone rubber molded body manufacturing device 1 in a stand-by state (retreat state), as illustrated in FIG. 1, the nozzle rotation mechanism 5 is in a position in which the nozzle rotation mechanism 5 is retreated from the press machine 10.

Then, when manufacturing is started, in Step S01, the supply nozzle 6 is rotated by 90 degrees by the nozzle rotation mechanism 5 and, as illustrated in FIG. 2, the supply nozzle 6 is set over the upper surface 11a of the core 11. As illustrated in FIG. 3A, a position of the supply nozzle 6 is substantially over a center of the mold (the core 11) and a height H is in a position about 100 mm above the upper surface 11a of the core 11.

Next, in Step S02, a supply button (not illustrated) of the LSR supply device 2 (the control section) is pressed.

Subsequently, in Step S03, as illustrated in FIG. 3B, liquid silicone rubber 50 mixed by the static mixer 4 is supplied to the upper surface 11a of the core 11. The supplied liquid silicone rubber 50 is in a state where the liquid silicone rubber 50 is raised so as to coil like a soft ice cream. The higher a supply speed of the liquid silicone rubber 50 is, the more advantageous it is, but the supply speed is, for example, about 53 cc/sec as described above.

Next, in Step S04, when supply of the material ends, in a cutting step, the material is cut by a nozzle tip end, for example, using a resin spoon. FIG. 3B illustrates a state after the cutting step. In a state where supply of the liquid silicone rubber 50 is stopped, the liquid silicone rubber 50 is filled in a gap between the liquid silicone rubber 50 that has coiled up and a tip end of the supply nozzle 6 to a certain extend to connect therebetween, and therefore, the liquid silicone rubber 50 is not scattered to the press machine 10 and surrounds thereof by reliably cutting the liquid silicone rubber 50 during the cutting step.

Next, in Step S05, the supply nozzle 6 is rotated by 90 degrees to be returned to the stand-by position illustrated in FIG. 1.

Next, in Step 06, a press start button (not illustrated) of the control section 7 is pressed.

Subsequently, in Step S07, as illustrated in FIG. 3C, when the upper mold 12 is closed, the upper mold 12 and the lower mold 13 has been drawn and, at the same time, moving of the upper mold 12 and the lower mold 13 to a drawing completion position is completed, the core 11 is raised up and a press pressure is increased to a predetermined pressure to start molding. That is, the liquid silicone rubber 50 is pressurized and heated while being filled into the cavity 15 of the lower mold 13 and the upper mold 12, so that the silicone rubber molded body 51 is molded. The mold of the press machine 10 is opened, the molded silicone rubber molded body 51 is removed, burrs or the like are removed, and thus a final product is obtained.

On the other hand, in Step S08, in the LSR supply device 2, a material is supplied to the pump syringe of the LSR supply device 2 from the pail pump 3 and, when a predetermined amount of the material has been supplied and supply of the material for a next shot is completed, the LSR supply device 2 and the pail pump 3 stop a supply operation. Then, the process returns to Step S01.

Then, an operation from Step S01 to Step S08 is repeated.

In this embodiment, since the liquid silicone rubber 50 having flowability is supplied to the upper surface 11a of the core 11 of the press machine 10, a preparatory molding step can be omitted and a compression mold having a simple structure without an injection gate can be used, so that manufacturing cost can be reduced. With the compression mold having a simple structure, maintenance and management of the mold is easy and thus maintenance cost can be suppressed.

Furthermore, the silicone rubber molded body manufacturing device 1 does not employ an injection molding machine that requires a large-scale facility but can employ the press machine 10 having a relatively simple structure.

Moreover, a molded product can be molded at a lower temperature, as compared to normal compression molding, and a shrinkage rate is small, so that a highly precise molded product can be obtained. For example, for the silicone rubber molded body 51 having a diameter of 300 mm, molding with an outer diameter precision of ±0.3 mm or less was possible. A yield of 95% or more was achieved.

Conventionally, liquid silicone rubber is molded by injection molding but, in this embodiment, as compared to injection molding, liquid silicone rubber is used in compression molding using a compression mold that can be manufactured at low manufacturing cost, and therefore, molding can be performed at a low temperature. Therefore, variations in outer shape dimensions can be suppressed and the highly precise silicone rubber molded body 51 can be obtained.

### Modified Examples

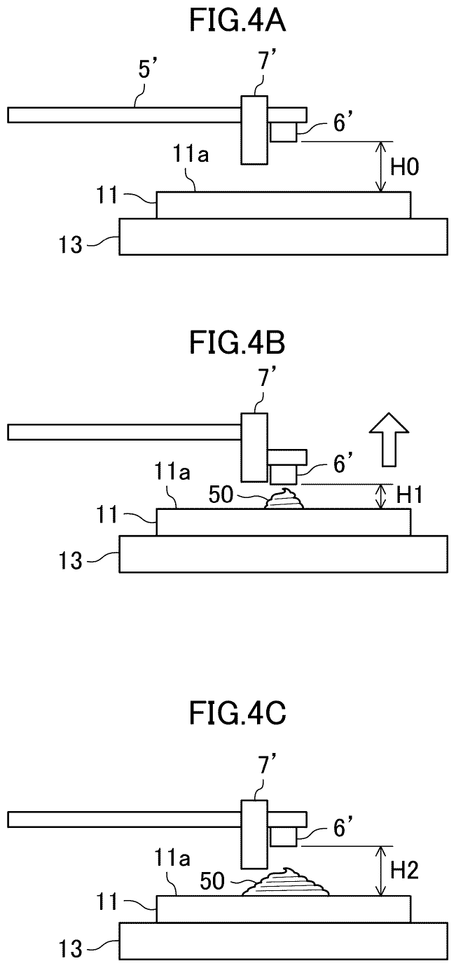

In this modified example, as illustrated in FIG. 4A to FIG. 4C, a configuration in which, when the liquid silicone rubber 50 is supplied from a supply nozzle 6′, the supply nozzle 6′ can be lifted as the liquid silicone rubber 50 is raised is employed.

Specifically, in this modified example, a lifting and lowering section 7′ that lifts and lowers the supply nozzle 6′ is provided at a tip end of a nozzle rotation mechanism 5′. There is no particular limitation on an actuator, and the actuator may be an air cylinder and may be an electric motor.

For example, as illustrated in FIG. 4A, an initial height H0 when the supply nozzle 6′ is rotated from an avoidance position to a supply position is, for example, H0=100 mm.

As illustrated in FIG. 4B, before starting supply, the supply nozzle 6′ is lowered to a height of H1=50 mm. Entrapping of air when a material is supplied can be prevented by lowering the supply nozzle 6′ as much as possible.

Furthermore, as illustrated in FIG. 4C, the supply nozzle 6′ is lifted to a height of H2 in accordance with supply of the material. H2 is, for example, 100 mm.

Therefore, in this modified example, even when a large amount of the liquid silicone rubber 50 is supplied at a high speed, the supply nozzle 6′ is not buried in the raised liquid silicone rubber 50 and entrapping of air is also prevented.

Based on the foregoing, according to the method for molding an elastic body according to this embodiment and the method for molding an elastic body according to the modified example described above, the respective problems of injection molding and compression molding can be solved and molding of the silicone rubber molded body 51 at low cost and with high precision can be performed.

### Other Embodiments

According to the present disclosure, the embodiment described above may be also configured in the following manner.

That is, in the embodiment described above, the molding material is liquid silicone rubber, but is not limited thereto. The molding material may be some other molding material, such as a thermosetting molding material or a thermoplastic molding material, that can be supplied at a high speed and has a proper viscosity that allows the material to flow into the entire cavity 15 up to all edges of the cavity 15.

Although, in the embodiment described above, the elastic body is the silicone rubber molded body 51 having a thin disk-like shape, the elastic body may be one that is used for some other purpose, has some other shape, and is formed of some other material. Even the elastic body having a particularly complicated shape can be molded at a high speed and at low cost.

In the embodiment described above, as an example of the control section (controller), a microcomputer is described. However, the control section may be configured physically in any way, as long as the control section controls the silicone rubber molded body manufacturing device 1. For example, the control section may be a microcomputer, a programable logic controller (PLC), or the like that employs a software (program). Alternatively, the control section may be realized by combining multiple pieces of hardware (circuit components).

Note that the above-described embodiments are merely preferable examples by nature and are not intended to be particularly limiting the present disclosure, application of the present disclosure, and the scope of use.

What is claimed is:

1. A method for molding an elastic body, the method comprising:
supplying a molding material having flowability to an upper surface of a mold attached to a press machine from a movable supply nozzle provided at a tip end of a molding material supply device such that the molding material is raised;
moving the supply nozzle to cause the supply nozzle to avoid the mold; and
molding a molded product by performing clamping of the press machine and pressuring and heating the molding material while filling the molding material into a cavity of the mold.

2. The method for molding an elastic body according to claim 1, wherein
the mold includes an upper mold, a lower mold, and a core that is interposed between the upper mold and the lower mold to form the cavity and the molding material having flowability to an upper surface of the core such that the molding material is raised.

3. The method for molding an elastic body according to claim 1, further comprising:
rotating the supply nozzle to cause the supply nozzle to avoid the mold.

4. The method for molding an elastic body according to claim 2, further comprising:
rotating the supply nozzle to cause the supply nozzle to avoid the mold.

5. The method for molding an elastic body according to claim 1, wherein
the molding material is liquid silicone rubber and is pressurized and heated by the press machine to be heat cured.

6. The method for molding an elastic body according to claim 2, wherein
the molding material is liquid silicone rubber and is pressurized and heated by the press machine to be heat cured.

7. The method for molding an elastic body according to claim 5, wherein
the molding material is a mixture of two or more liquid silicone rubbers and is pressurized and heated by the press machine to be heat cured.

8. The method for molding an elastic body according to claim 6, wherein
the molding material is a mixture of two or more liquid silicone rubbers and is pressurized and heated by the press machine to be heat cured.

9. The method for molding an elastic body according to claim 1, wherein
when the molding material is supplied from the supply nozzle, the supply nozzle is lifted as the molding material is raised.

10. The method for molding an elastic body according to claim 2, wherein
when the molding material is supplied from the supply nozzle, the supply nozzle is lifted as the molding material is raised.

11. The method for molding an elastic body according to claim 1, further comprising:
cutting, after supply of the molding material from the supply nozzle ends, a connection portion of the supply nozzle and the molding material.

12. The method for molding an elastic body according to claim 2, further comprising:
cutting, after supply of the molding material from the supply nozzle ends, a connection portion of the supply nozzle and the molding material.

13. An elastic body molding device comprising:
a molding material supply device that mixes two or more liquid silicone rubbers to supply a liquid molding material;
a supply nozzle that can move to change a supply position in which the molding material that is supplied from the molding material supply device is suppled; and
a press machine that molds a molded product by receiving the supply nozzle between parts of a mold attached to the press machine, supplying the molding material with flowability that is supplied from the supply nozzle to an upper surface of the mold such that the molding material is raised, and performing clamping in a state where the supply nozzle is moved to avoid the mold and pressurizing and heating the molding material while filling the molding material into a cavity of the mold.
